(19) United States
(12) Patent Application Publication
(10) Pub. No.: US 2026/0225181 A1
(43) Pub. Date: Aug. 6, 2026

(54) HIGH-POWER LASER SYSTEM FOR FORMING LASER IRRADIATION ZONE WITH SPECIFIED DIMENSIONS AND POWER DENSITY DISTRIBUTION FOR THERMAL SURFACE TREATMENT APPLICATIONS

(71) Applicant: IPG PHOTONICS CORPORATION, Marlborough, MA (US)

(72) Inventors: Valentin FOMIN, Marlborough, MA (US); Andrey ABRAMOV, Marlborough, MA (US); Mikhail ABRAMOV, Marlborough, MA (US); Alexander DRONOV, Marlborough, MA (US); Dmitry JAGODKIN, Marlborough, MA (US); Alexander MAKAGON, Marlborough, MA (US)

(73) Assignee: IPG PHOTONICS CORPORATION, Marlborough, MA (US)

(21) Appl. No.: 19/150,609

(22) PCT Filed: Jan. 29, 2024
(86) PCT No.: PCT/US2024/013291

§ 371 Date: Jul. 24, 2025

Related U.S. Application Data
(60) Provisional application No. 63/441,520, filed on Jan. 27, 2023.

(51) Int. Cl. B23K 26/06; B23K 26/064; B23K 26/073; B23K 26/082; B23K 26/352

(52) U.S. Cl. CPC B23K 26/0608; B23K 26/064; B23K 26/0732; B23K 26/082; B23K 26/352

(57) ABSTRACT

A high-power laser system for thermally treating a surface is configured with one or more laser sources generating respective source beams with respective arbitrary powers and at respective wavelengths. The source beams are delivered to a laser head via respective fiber trains which have respective output ends terminated within the laser head. Mounted in the laser head is an optical mixer having its input face opposing the output ends of respective fiber trains which form together the predetermined spatial arrangement. The optical mixer is configured to receive the source output beams from respective output fiber ends so as to combine and shape the coupled output beams into at least one system output beam forming a beam spot with the desired PDD and desired shape.

### BACKGROUND OF THE DISCLOSURE

### Field of the Disclosure

The present disclosure relates to a laser system for thermal surface treatment applications. In particular, the disclosure relates to the laser system in which multiple fiber trains guide respective source beams each with an arbitrary power density distribution (PDD) to an optical mixer configured to combine the source beams into a system output beam having a beam spot with a predetermined shape and desired PDD on the irradiated surface.

### Prior Art Discussion

Laser surface treatment is a thermal process using high power density laser beam to heat the material surface in a non-contact way. Traditional small and large surface area laser treatment technologies such as laser cleaning, laser quenching, laser alloying, laser shock strengthening, laser annealing, as well as laser cladding, laser 3D printing, laser electroplating and other technologies have brought about limitless application prospects. Some of these prospects, which at least partially have been realized, include drying printed water-or solvent-based dispersions applied preferably, but not exclusively to large-area substrates or components.

For example, in recent years, laser-based drying of anode and cathode layers can be used in the manufacturing of batteries. To achieve the temperature ranges required for increasing the coating/drying speeds, the near-infrared wavelength spectrum has been shown to be particularly promising in previous research projects. This wavelength spectrum is typically, but not exclusively, achieved by semiconductor or fiber lasers. Compared to the traditional oven drying process, the laser process could reduce the energy consumption. Nevertheless, up to now, the laser process could not reach processing speeds required in accordance with the industrial needs. This limitation is being gradually overcome by increased laser powers and parameter optimization.

The principle configuration of the known laser drying systems is shown in FIG. 1 and includes a fiber-coupled diode laser or fiber laser which generates light delivered to a laser head 2 by a fiber 1 for scanning the surface to be treated 3 along a scanning line 4. FIG. 2 illustrates a somewhat detail configuration of one of the known laser surface treating systems for drying water-based electrodes made of slurries of active material powders, binders, solvents, and conductive agents and further additives for lithium-ion battery cells. The laser module scans the coating surface while the coating is conveyed underneath as shown in FIG. 2 which illustrates the laser module directly juxtaposed with the surface to be treated. However, in fact, the laser radiation is generated remotely and fed to the process via the optical fiber or waveguide and laser head as shown in FIG. 1.

Heating with diode lasers allows for targeted, directional and highly controllable noncontact delivery of heat energy to the material to be treated. However the power scaling of the drying process requires combining numerous diode lasers in bars and further stacking these bars. Using bulk optics, the output of multiple stacks are sequentially combined based on the geometrical, polarization and/or then wavelength criteria. As a result, the combined parallel beam, characterized by different polarizations and wavelengths, is coupled into a single waveguide which typically has a large diameter associated with a variety of undesirable difficulties. One of the difficulties includes bending problems which may affect the waveguide reliability limiting further scaling and the power distribution across the combined beam spot deviating from the desired one which may be uniform or non-uniform.

Regardless of the desired PDD, to transform the arbitrary PDD into the desired PDD, it is known to implement an optical element, i.e., beam shaper configured to substantially shape the arbitrary beam's PDD. A variety of configurations of the beam shapers are known and include, among others, periodic microlens arrays, phase masks, and light pipes all used to obtain the desired PDD from the arbitrary one. The limitations of the above-mentioned shapers at the required high powers may include, among others, power losses reaching 10%, manufacturing and maintenance costs, large footprint, and low reliability. Based on the foregoing, the laser bar stack light sources may have a limited industrial application.

It is, therefore, desirable to provide a laser system for thermally treating material powders, binders, solvents, inks and various additives on large-surface areas, wherein the laser system:
overcomes power limitations of the known laser systems and disadvantages associated with large-diameter delivery waveguide; and
is configured with an optical mixer mounted in a laser head and structured to simultaneously
combine multiple laser source outputs having respecting arbitrary PDDs into a single or multiple high power output system beam or beams irradiating a surface zone so as to provide the desired PDD distribution across the beam spot and zone shape, and
shape the received outputs together so as to provide the irradiated surface zone with the predetermined shape and dimensions.

### BRIEF SUMMARY OF THE DISCLOSURE

The disclosed direct diode laser system is configured with an optical system structured to control a system output beam, which irradiates a zone on the surface to be laser treated, so that the output beam forms a beam spot on the surface providing the zone with the predetermined shape and desired PDD. The disclosed system is particularly, but not exclusively, advantageous for the drying technologies due to its power scalability and energy efficiency which meet the ever-growing industry demands. The system includes a laser source operating within a broad power range, fiber-based beam delivery system and a laser head enclosing an optical element, further referred to as optical mixer and an imaging system. The disclosed laser system provides the laser irradiated surface zone with the desired shape, dimensions and PDD.

In accordance with one feature of the disclosure, the laser source includes one or more numerous laser modules (LM) each outputting a 1-5 KW LM source beam, whereas a combined system output, depending on the number of laser modules, may vary within a 1-100 KW range which, if necessary, can be expanded. Each LM includes a solid state laser selected from multiple direct diode laser associated with an output fiber, pigtailed (fiber coupled) laser diode (PLD) emitters. While diode lasers are the most efficient among the mentioned laser types, the experiments show that fiber lasers alone or in combination with diode lasers can be effectively used because the wall-plug efficiency (WPE) of fiber lasers is comparable to that of the laser diodes. Accordingly, the disclosed here inventive system may be practiced with either diode or fiber lasers or their combination, and the disclosed below particularities based on pigtailed diode lasers are applicable to fiber lasers.

In accordance with one aspect of the disclosure, the arrangement of the downstream ends of respective fiber trains relative to the input face of the mixer is predetermined. Geometrically, the fiber end arrangement may be polygonal, circular or irregular. The position of the fiber ends relative to the input face of the mixer defines where any given LM output beam initially hits the mixer's peripheral surface affecting the PDD at the system output beam so to provide the irradiated zone with the desired PDD profile. Multiple LMs can operate at different wavelengths and/or different output powers. In fact, each individual LM may be configured with multiple PLDs operating at respective wavelengths which differ from one another. Accordingly, it may be desirable that the LM outputs be grouped based on, for example, different wavelengths and/or different powers leading to multiple regions with respective different PDDs across the beam spot on the irradiated zone. Alternatively, the PDD profile across the output beam spot and thus the irradiated zone may be uniform. Another aspect of the disclosure relates to the disclosed system in which the mixer is positioned relative to the surface to be laser treated at an angle differing from the right angle. Perhaps, reflecting on life never having pitch black or snow white but different shades and tints, the mixer's shape may influence not only the beam-shape, but also the PDD across the beam and irradiated zone. Once the normally mounted mixer is angularly displaced relative to the surface, the shape of the beam spot and that of the irradiated zone may differ from respective beam spot's shape associated with the normal position of the mixer. One end of the beam spot and zone irradiated by the angularly displaced mixer may remain the same or become narrower, whereas the other end gets broader. A good example of the distortion of the shapes in question is, for example, a rectangular mixer which, if inclined, provides the beam spot and the irradiated zone with a trapezoidal shape. Another example is the circularly-shaped mixer, which when displaced from the normal position, is responsible for the elliptically irradiated zone. The modification of the desired shape affects the PDD within the irradiated zone: the regions of the beam and zone which get narrower are characterized by a PDD which is higher than that of the broadened regions. If the goal is to provide the uniformity of the PDD, the deviation of the zone's shape from the desired obviously would make this goal unrealistic. However, replacing the rectangular mixer with a trapezoidal mixer restores the desired rectangular beam shape. While the uniformity of the PDD is required in some applications, the non-uniform PDD may be preferred in other applications. In the example of the rectangular mixer, it would be sufficient to simply incline the rectangular mixer to receive the desired nonuniform PDD profile.

The above and other features and advantages of the disclosed system are discussed in detail below. Moreover, it is to be understood that both the foregoing information and the following detailed description are merely illustrative examples of various aspects and embodiments, and are intended to provide an overview or framework for understanding the nature and character of the claimed aspects and features. The features disclosed herein may be combined with other features, and references to “an embodiment” and “an example” are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various structural features of at least one embodiment are discussed below with reference to the accompanying figures, which are not intended to be drawn to scale. The figures are included to provide an illustration and a further understanding of the various aspects, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an exemplary laser system preferably, but not exclusively used in drying and coating technologies;

FIG. 2 illustrates one of the known laser systems utilized for drying water-based electrodes made of slurries for lithium-ion battery cells;

FIG. 3A illustrates the exemplary inventive laser system;

FIG. 3B is a graph illustrating estimated annual savings on energy and costs of the system of FIG. 3A operating in different wall plug efficiency (WPE) regimes;

FIG. 4A illustrates a high power laser source of the inventive system of FIG. 3;

FIG. 4B is a diagrammatic optical schematic of an individual laser module (LM);

FIG. 5A is a side sectional view of the laser head of the inventive system of FIG. 3A;

FIG. 5B is a simplified diagrammatic view of the laser head of FIG. 5A;

FIG. 6A illustrates an exemplary spatial arrangements of fiber trains' ends connected to respective quartz blocks in the laser head of FIG. 5;

FIG. 6B illustrates the fiber ends directly coupled to the optical element of FIGS. 5 and 6A;

FIG. 7 is an exemplary diagrammatic perspective view of an optical element of FIG. 5 configured with an exemplary irregular shape;

FIG. 8A illustrates the rectangularly-shaped mixer incorporated in inventive laser system and positioned at an angle relative to the surface to be laser treated which is different from the right one;

FIGS. 8B and 8C illustrate the PDD within a zone irradiated by the system of FIG. 8A;

FIG. 9A illustrates the trapezoidal mixer incorporated in the inventive laser system;

FIGS. 9B, 9C illustrated the PDD within the zone irradiated by the system of FIG. 9A;

FIG. 10A illustrates the inventive laser system with a plurality of angularly mounted laser heads provided with respective mixers of FIG. 9A;

FIGS. 10B and 10C illustrate laser PDD within the surface zone irradiated by the laser system of FIG. 10A;

FIG. 11 illustrates the inventive laser system of FIG. 10A provided with a scanner; and

FIG. 12 illustrates a conceptual implementation of the inventive laser system for industrial-scale drying operation of the water-based electrodes of FIG. 2; and

FIG. 13 is an orthogonal view of exemplary trapezoidal mixer incorporated in configurations of respective FIGS. 9A, 10A and 12.

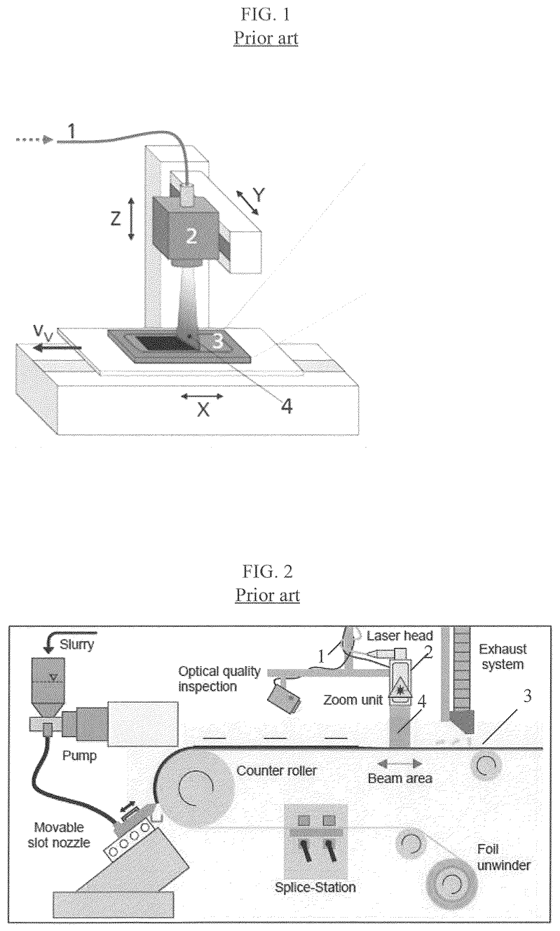

### SPECIFIC DESCRIPTION

To highlight the background of this invention, numerous laser systems based on various types of solid state lasers has been tested in coating/drying technologies including food industry, lithium ion cell battery production and other technologies which may require thermally treating surfaces. While the laser systems proved to be more efficient than many conventional thermal treating methods, a few disadvantages of these systems have been well documented. One of the known disadvantages includes limited possibilities of power scaling due to a large-diameter delivery fiber(s) capable of guiding high power light necessary to meet the industry-standard process speeds. It is particularly relevant to the systems based on laser bar stacks which are highly desirable in use because of their high wall plug efficiency (WPE). Such delivery fibers easily bend which leads to the excessive power losses and impractical footprints. Furthermore, the bean combining operations in these surface thermal treating laser systems require complex, cost-inefficient beam combiners. Still another notable disadvantage of the known laser systems relates to the use of complex, cost-inefficient, power loss prone optical beam shaper typically used for obtaining flattop beams and referred to as homogenizers.

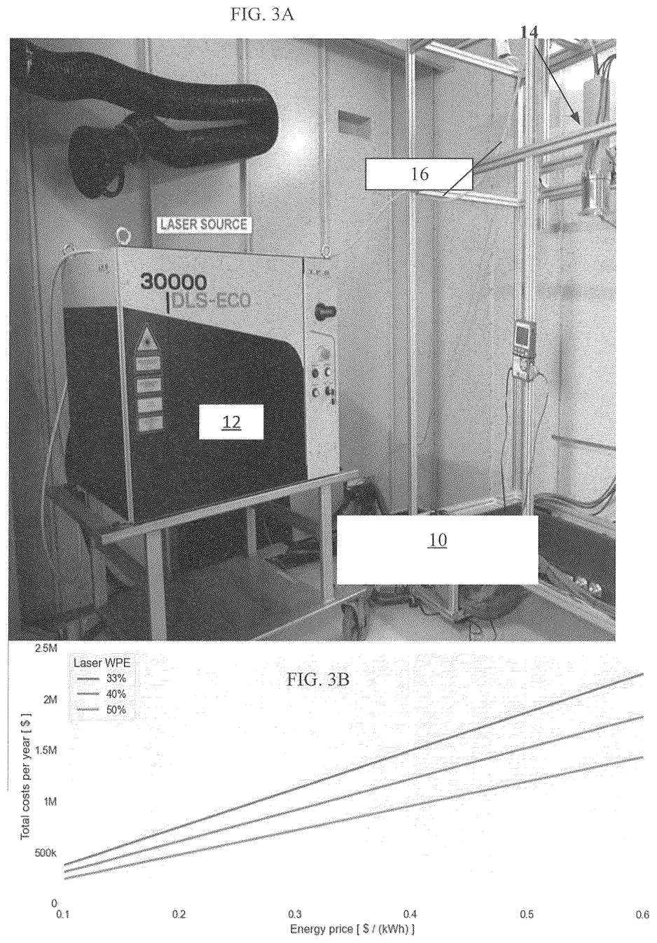

With the above and other disadvantages of the known thermal surface laser systems in mind, FIG. 3A illustrates an exemplary laser system 10 configured in accordance with the inventive concept to overcome the above-discussed disadvantage of the known systems. The system 10 is configured with a high power laser source 12 generating, for example, a 30 KW output which is delivered to a laser/processing head 14 by a cable 16 shielding a plurality of feed fibers which carry respective outputs of laser source 10 to laser head 14. As shown in FIG. 3A, system 10 is referred to as DLS-ECO is known for its high WPE equal to or exceeding 50% and optical losses less than 2% and, under certain conditions, less than 1%. Obviously, different characteristics of system 10 can be used provided such a system meets the industry requirements such as the process speeds.

FIG. 3B illustrates estimated savings on energy and cost of inventive system 10 of FIG. 3A operating in three different energy regimes. The least cost efficient regime corresponds to 33% WPE, whereas system 20 operating in the most cost efficient regime has 50% WPE. The examples are based on the following conditions: 298 working days, 2 shifts per day, i.e., 16 hours operation per day, 75% laser duty cycle per shift, and chiller coefficient of performance of 4.35 (Cooling capacity/Electrical consumption, kW/kW.)

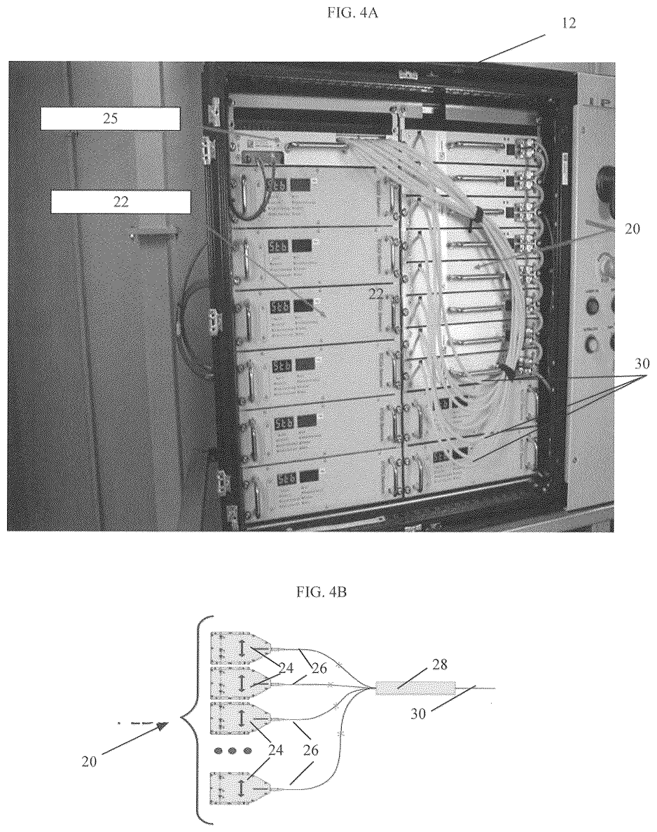

Referring to FIGS. 4A and 4B, high power laser source 12 is configured with a plurality of LMs 20 which are energized by respective power supply modules 22. The exemplary eight LMs 20 of illustrated power source 12 each may output 3750 W which amounts to the system's output of 30 KW. Such a high-power output of each LM 20 is a result of having a plurality of multimode (MM) high power laser diodes PLD in each LM 20 which is diagrammatically illustrated in FIG. 4B. Just as an example, illustrated LMs 20 each are energized by eighteen PLDs 24 each of which has nine individual laser diodes. The MM outputs of respective PLDs 20 are guided through respective PLD output fibers 26. The latter are further combined by a fiber combiner 28 which has output fiber 30 receiving the LM output beam. The structural examples of PLDs 24, their parameters and characteristics are published at https://www.ipgphotonics.com and fully incorporated herein by reference.

The LM delivery fibers 30 guide respective LM output beams to a splice module 25 of FIG. 4A where these fibers 30 are spliced to respective feed fibers 32 (see FIG. 5 and FIG. 3A showing a sleeve 16 traversed by a plurality of feed fibers 32) providing thus optical communication between laser source 12 and laser head 14 of FIG. 3A. It should be noted PLDs 24 or other solid-laser types of FIG. 4B may operate at the same or different respective operating wavelengths and with uniform or respective different powers. As a consequence, LMs 20 each may output the LM output beam at the same or different wavelengths and powers. The combiners 28 of FIG. 4B may be omitted with the outputs of respective LMs 20 coupled directly to respective delivery fibers 30 connected to feed fibers 32 in splice module 25 of FIG. 4A. With or without the fiber combiner, the optical communication between power source 12 including a plurality of LMs 20 and laser head 14 is realized by multiple fiber trains each including at least spliced together delivery and feed fibers.

Referring to FIGS. 5A and 5B, laser head 14 is provided with a housing50 receiving respective LM output fibers 30 which are coupled to respective feed fibers 32. The downstream ends of respective feed fibers 22 each have respective downstream fiber ends each directly coupled to a few mm-long AR-coated quartz block 34. The blocks 34 are arranged so that the fiber ends are positioned relative to one another and to an input face 38 of optical mixer 36 in a predetermined arrangement. The optical mixer 36 is configured to combine the outputs from respective feed fibers 32 into a single system output beam with the desired shape of the beam spot on the surface to be laser treated. The mixer 36 may include a variety of polygonal shapes or conical sections such as circular, oval and etc. In the normal position of laser head 14 relative to the surface to be treated, the system output beam spot and therefore the irradiated zone have the same shape as mixer 36.

The exemplary mixer 14 of FIGS. 5A and 5B is a quartz block (n=1.45) of rectangular shape (here 10×40×100 mm). It is used to homogenize the emission of input spots of the fibers by means of multiple reflections from mixer's side surfaces. Input and output optical faces 38, 40 respectively of the mixer are AR-coated at PLD's wavelength; side surfaces are intentionally not coated-mostly they have contact with air (n=1.0) and only places of mechanical fixations of the mixer are done by the means of high NA silicone (n=1.38). It allows mixer 14 to conduct emission of input fibers by means of total internal reflection, mixing it together, to its output end-face 40.

Returning to the downstream ends of respective feed fibers 32, its arrangement is critical for creating the desired PDD profile across the system output beam spot and irradiated zone since coupled into laser mixer 36 LM outputs may have respective wavelengths and powers different from one another or uniform. As a result, the combined system output beam decoupled from output face 40 of mixer 36 creates a beam spot, defining the irradiated zone, which is formed with regions having uniform or non-uniform wavelengths and, most importantly, power densities. As a consequence, the PDD within the irradiated zone may be uniform and non-uniform, such as, increasing from one end region of the beam spot to the opposite end, or having alternating regions with and low PDD or any other non-uniform power distribution capable of meeting the process requirements.

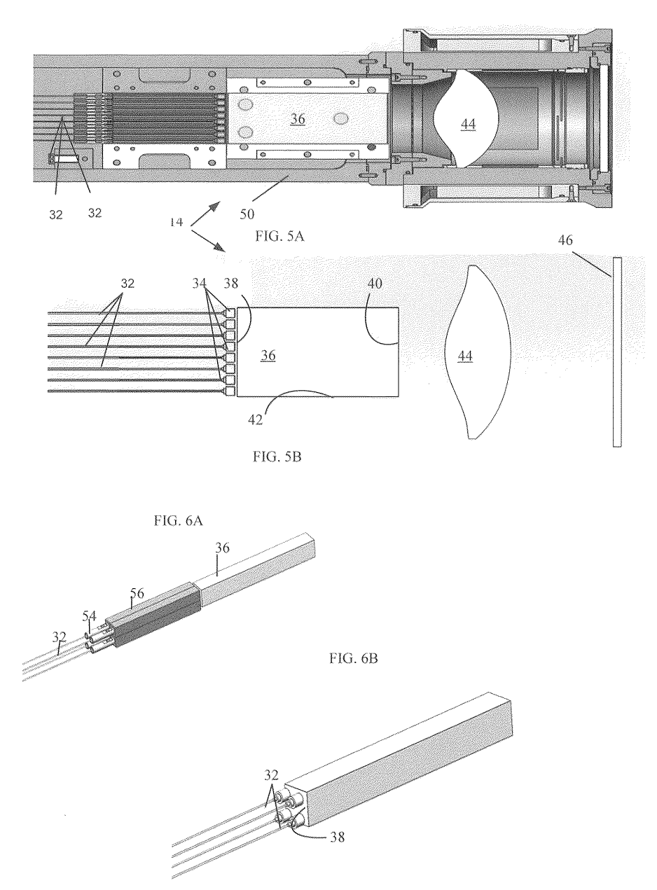

The exemplary arrangements of the fiber end arrangements is illustrated in FIGS. 6A and 6B. In particular, FIG. 6A illustrates multiple feed fibers 32 extending through respective supports 54 into an element 56 which covers respective quartz blocks 34 of FIG. 5B. The fiber ends are positioned to form a square-shaped arrangement. A variety of fiber end arrangements can be easily realized by one of ordinary skill. For example, the fiber ends may be arranged so that the fiber ends/quartz blocks of one of the multiple rows straddle respective fiber ends/blocks of adjacent rows. Alternatively, fiber ends/blocks can be positioned to define one or multiple concentric or adjacent circular arrangements. Practically any geometrical arrangement of fiber ends is contemplated with the scope of this disclosure as long as respective positions are preliminary calculated to produce the predetermined PDD of the output system beam. Importantly, source beams guided in respective feed fibers 32 may different PDDs and/or wavelengths or uniform PDD and/or wavelength FIG. 6B illustrates a different structural modification in which fiber ends of respective feed fibers 32 are directly coupled/fused to input face 38 of mixer 36. As discussed above, the spatial arrangements of directly coupled fiber ends 32 are numerous and limited only by the desired PDD of the output system beam.

Returning to mixer 36 of FIG. 5B, there are two approaches of guiding the coupled into LM beams between input face 38 and output face 40. One approach incorporates the total internal reflection phenomenon (TIR) in accordance with which the coupled LM beams are incident on the interface between peripheral wall 42 of component 36 and the medium outside the latter at the angle exceeding the critical angle of the interface. The other condition necessary to produce this phenomenon is the relationship between indices of respective material of element 36 and the outside medium in which the index of the material is higher than that of the outside medium. The component 36 is made from transparent material including, but not limited to quartz, its refractive index n=1.45 which is higher than that of the outside medium, for example i.e., the air (n=1.00). As a result of the TIR phenomenon, the coupled beams undergo multiple reflections from peripheral wall 42. In accordance with this method, only input and out faces 38, 40 of element 36 may have respective AR coatings which, under certain conditions, may be omitted. Besides air, component 36 occasionally comes into contact with high numerical aperture NA silicone (n=1.38) at spaced apart locations requiring mechanical fixations of the component.

Multiple internal reflections of beams intensify the beam mixing along the entire length of optical mixer 36 and cause the combined output system beam to assume the flattop PDD characterized by the desired PDD on the irradiated zone of the surface to be laser treated. Accordingly, the laser irradiated zone on the surface to be treated has the specified dimensions, shape and desired PDD. Preferably the inner surface of wall 42 is smooth which minimizes diffusion power losses.

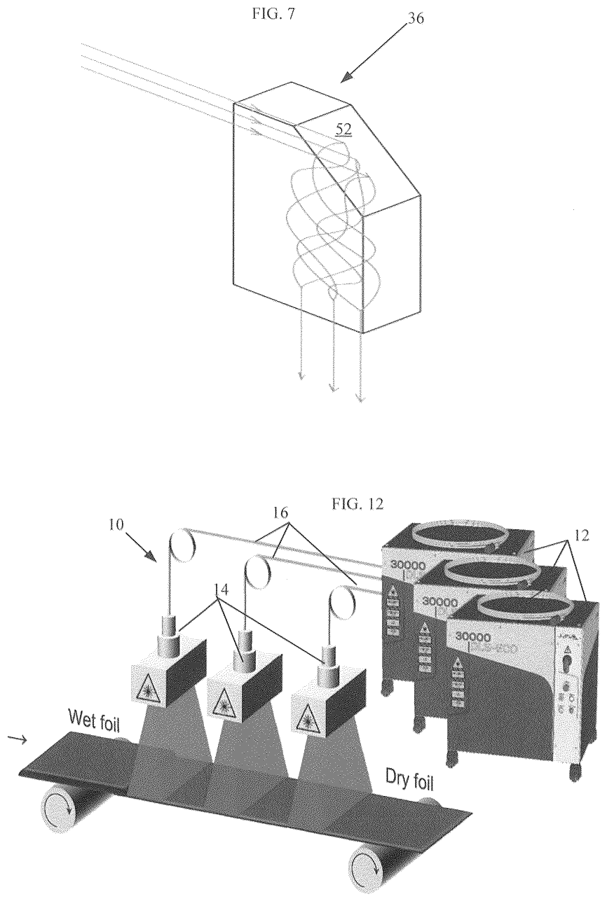

The other method of beam mixing in mixer 36 includes coating its peripheral wall 42 with, for example, a metallic or dielectric film producing the mirror effect. This method also provides for both regular and irregular shapes of mixer 36. For example, as shown in FIG. 7, multiple LM beams propagating along the initial path are coupled into element 36 through a vertical input side and are incident on a slanted side 52. The latter redirects the incident light along a path perpendicular to the initial one with the reflected beams exiting the bottom of the shown structure. Except for the input and output bottom sides, the remaining peripheral sides are covered with the coating reflecting the light inwards multiple times which improves beam mixing. The shape illustrated in FIG. 7 is referred to as the irregular shape. One of ordinary skill readily realizes that a great variety of irregular shapes of mixer 36 may be configured and used here without contradicting the inventive concept of the disclosed system.

The dimensions of the spot size on the surface can be controlled by displacement of laser head 14 along a z-axis. The head also may be provided with the zoom mechanism. While the working distance in exemplary systems 10 was somewhat between 0.1 and 5 meters, on several occasions the working distance was increased to 20 meters the linearly changed beam spots on the surface to be treated typically had the PDD unchanged.

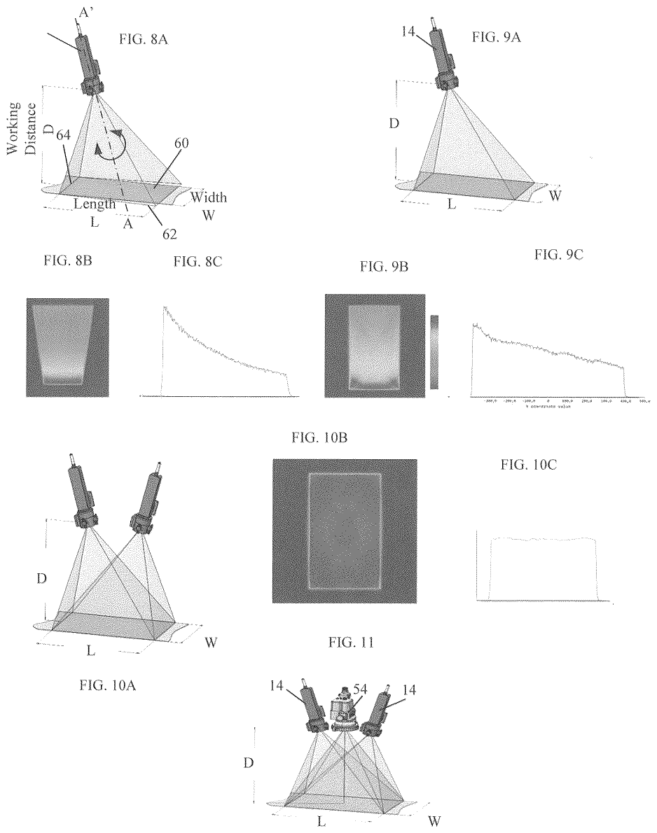

FIGS. 8A-8C relate to a specific industrial application in which mixer 36 of FIG. 5B extending along axis A-A′ is displaceable from a normal position relative to the surface to be treated in an angular range between about 0° and 65°. The angular displacement of the mixer may require replacing one shape of the mixer with another in order to assist the fiber end arrangement in providing the irradiated zone with the desired PDD.

As one of ordinary skill in the optical arts readily realizes, the beam spot and irradiated zone may assume the shape different from, for example, that of mixer 36 if the latter is displaced from its normal position. In the normal position of mixer 36 relative to the surface to be laser treated, the beam spot and zone have the same rectangular shape. But, as shown in FIG. 8B, the shape of the beam spot and zone is different from the rectangular one. In fact the shape is substantially trapezoidal. As a result of such displacement, one end of irradiated zone 60—end region 64 closest to the output end of laser head 14—remains practically unchanged, whereas the distant end region 62 expands. In other words, with rectangular mixer 36 displaced at some angle, the rectangular shape of the beam spot assumes a trapezoidal section. The latter, of course, affects the PDD across zone 60 with broad end region 62 having the PDD lower than that of opposite end 64 as clearly shown in FIGS. 8B and 8C. One of ordinary skill in the optical arts would not have any difficulty to determine the desired angle within the above-mentioned angular range to provide the zone with the predetermined dimensions. The displacement of the laser head with the mixer or just the mixer within the laser head at the desired angle can be realized by utilizing well known actuators receiving, for example, a signal from a central processing unit which typically is incorporated in the systems similar to the disclosed one.

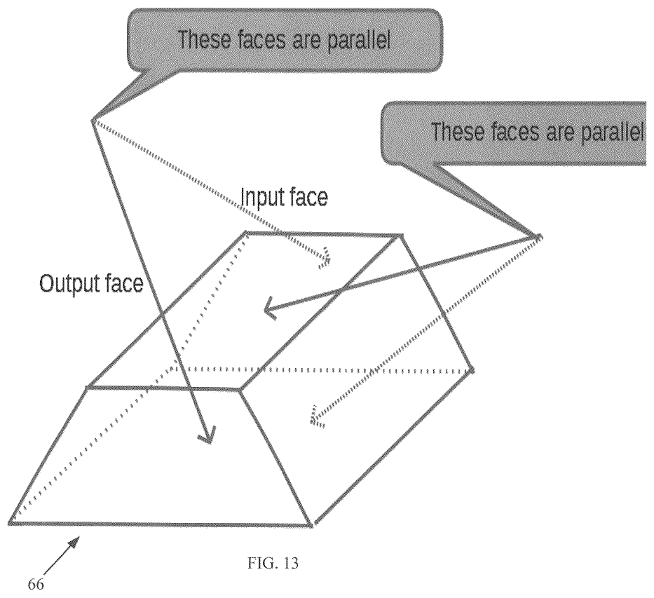

FIGS. 9A-9C and 14 illustrate the solution to the problem discussed immediately above. To compensate for the resulted uneven PDD due to the angle of incidence and distance, mixer 66 of laser head 14 is configured with a trapezoidal shape shown in FIG. 14. The angle between nonparallel sides of trapezoidal mixer of FIG. 13 is a function of the angle of incidence. The disclosed configuration of FIGS. 9A-9C thus provides the irradiated surface zone with a substantially rectangular shape characterized by the PDD which is much more homogeneous than that of FIGS. 8A-8C. One of the requirements for disclosed system 10 is the system's compactness. Pivoting the laser head 14 or mixer 36, for instance, at 45° reduces the vertical distance between the laser head and surface to be treated practically at 50% if compared to the normally-mounted laser head of FIG. 8A.

FIGS. 10A-10C illustrate the configuration of the inventive system including a plurality of laser heads 14 of FIG. 9A displaced in respective angular position from the normal position. One of the main advantages of having multiple laser heads 14 operating simultaneously includes the increased PDD inside the irradiated zone. The simultaneous operation of several laser heads 14 increases the power scalability and homogeneity of the PDD over the irradiated zone by comparison with single head 14 of FIG. 9A proportionally to the number of laser heads. As can be seen in FIGS. 10B and 10C, the PDD distribution over the zone irradiated by two laser heads is visually more constant than that associated with the single head of FIGS. 9B and 9C.

FIG. 11 illustrates another advantage of having the laser heads/mixers positioned in respective angular position of FIG. 10A. Any given process may require using additional process devices or components, such optical and/or metrological devices, powder- and gas-delivery nozzles etc., positioned between the shown laser heads. For example, in sintering/3D printing applications, the shown structure reduces the processing time from 3 to 5 times which increases productivity of this process. It also provides the possibility of using new materials, improved parameters and significantly reduced cost of part production.

Returning to FIGS. 5A-5B, laser head 14 is further configured with an imaging system including an objective 44, such as a spherical, cylindrical and aspherical lens and plain mirrors or curved mirrors downstream from component 36. Preferably, objective 44 is a complex-shaped aspherical lens forming the image of output end-face 40 of component 36 at a substantial working distance, such as 1450 mm, on the surface to be treated. As shown FIG. 5, objective 44 is spaced from optical element 36. However, an alternative structure may have optical element 36 and objective 44 coupled to form a one-piece component. In either configuration, the resulting size of the image is substantially larger than that of output face 40 and, in the example shown in the drawings, is 1300×300 mm. The working distance can be varied by several hundreds of mm with the image size changing linearly. However, the PDD uniformity of the irradiated zone stays substantially unchanged and lower than 20% and even lower than 10%. The assembly of laser head 14 is completed with the installment of a protective glass 46 covered with an AR coating and configured to protect the optics within laser head 14 against the debris from the surface to be treated. In the context of this disclosure, the imaging system may provide additional control of the PDD and shape of the beam spot and irradiated zone if necessary, as readily realized by one of ordinary skill in the optical arts.

Referring to FIG. 12, system 10 can be easily modified by adding additional systems operating with the uniform or different parameters. For example, as shown the entire assembly may have three uniformly configured systems 10 each including laser source 12, which is configured identically to that shown in FIG. 4A, and associated laser head 14 of FIGS. 6 and 7. The number of systems 10 is tailored to desired customer needs related to the length and width of illuminated surface 50, and power density on the foil to be treated. As understood by one of ordinary skill, each system may be individually controlled or all systems controlled by a single control unit. The outputs of respective systems may thus be generated simultaneously or in a time-independent manner to meet the customer's needs. The number of systems 10 are determined exclusively based on the customer's specification.

In regard to the multi-station of FIG. 12 and in light of the present disclosure, it is possible to use a single laser head receiving the source outputs from respective power sources. The optical mixer, as disclosed above, can be configured to provide a variety of regions within the beam spot and irradiated zone which have the uniform PDD or respective different PDDs. The speed of the band transporting the foil must be adopted to the laser power distribution and power density.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the following claims. Accordingly, the foregoing description and drawings are by way of example only.

What is claimed is:

1. A laser system for forming a zone with a predetermined shape and desired power density distribution (PDD) on the surface to be thermally treated, comprising:
a plurality of laser sources operable to controllably output respective source beams with respective non-controlled PDD;
a plurality of fiber trains guiding respective source beams along a path;
at least one laser head receiving downstream fiber ends of respective fiber trains;
an optical mixer mounted in the laser head and positioned opposite the fiber ends so as to receive, guide and combine the source beams into a system output beam, wherein
the optical mixer is configured to shape the system output beam so that it forms a beam spot defining the predetermined shape of the zone, and
the output fiber ends defining a spatial arrangement providing the desired PDD across the beam spot of the system output beam and within the surface zone.

2. The high-power laser system of claim 1, wherein the laser sources each include one or more fiber lasers, direct diode lasers or pigtailed diodes lasers, the fiber, direct or pigtailed diode lasers operating at a uniform power and wavelength or respective different powers and wavelengths.

3. The high-power laser system of claim 1, wherein the shaped of the optical mixer is selected from regular or irregular polygonal shapes or conical sections and configured with input and output spaced faces which are bridged by a peripheral wall, the input and output faces each being provided with an AR coating or being AR coating-free.

4. The high-power laser system of claim 3, wherein the spatial arrangement of the fiber ends is configured so that, upon coupling into the optical mixer, the coupled source beams being incident on and reflected from an inner surface of the peripheral wall, the inner surface of the peripheral wall being coated with a metallic or dielectric coating.

5. The high-power laser system of claim 4, wherein the optical mixer is made from transparent material having a refractive index higher than that of the outside medium, a relationship between refractive indices and the incidence angle cumulatively producing a total internal reflection effect with multiple reflections of the coupled laser source beams from the peripheral surface, wherein the reflected laser beams are mixed together to produce the system output beam with the desired PDD.

6. The high-power laser system of claim 1, wherein the output fiber ends of respective fiber trains are directly or indirectly coupled to the optical mixer.

7. The high-power laser system of claim 1, wherein the spatial arrangement of the output fiber ends includes a polygonal or circular arrangement which is selected to provide the desired PDD across the system output beam and within the surface zone, wherein the desired PDD being uniform or non-uniform.

8. The high-power laser system of claim 1, wherein the mixer is displaceable between a normal position to the surface to be treated and a plurality of angular positons at an angle which controllably varies between 0 and 65° to provide the beam spot and irradiated zone with the desired PDD and predetermined shape.

9. The high power laser system of claim 8, wherein the optical mixer is configured with a trapezoidal shape providing the beam spot which provides the zone with the predetermined shape and the desired uniform PDD upon angularly displacing the optical mixer to a predetermined angular position, the predetermined shape being rectangular.

10. The high power laser system of claim 9 further comprising at least two spaced apart laser heads with respective trapezoidal mixers each inclined at the angle so that respective system output beams overlap one another to irradiate the rectangular shaped surface zone which has the uniform PDD increased proportionally to a number of the trapezoidal laser heads.

11. The high power laser system of claim 10 further comprising at least one or more system components positioned between trapezoidal laser head.

12. The high-power laser system of claim 1 further comprising a plurality of additional optical laser heads arranged in a predetermined spatial pattern to output respective system output beams forming respective beam spots which have uniform or respective different PDDs and shapes.

13. The high-power laser system of claim 1 further comprising an imaging system mounted in the laser head downstream from the optical mixer and configured with refractive- or mirror-based optics, wherein the imaging system includes one or more aspherical, spherical or cylindrical lens or plane or curved mirrors, wherein the optical mixer and imaging system are spaced apart or coupled together to form a one-piece body or spaced apart.

14. The high-power laser system of claim 11, wherein the flattop PDD of the output system beam is characterized with a 1-20% of non-uniformity.

15. The high-power laser system of claim 8, wherein the laser head is displaceable along a Z axis in a 0.1 to 5 m distance range, so as to linearly affect dimensions of the surface zone.

16. The high-power laser system of claim 1, wherein the laser sources are combined in one or more laser modules each operative to output the source beam in a 1-100 KW power range, the source beams being coupled into the optical mixer of the one laser head configured to output the system output beam having the beam spot which is characterized by the predetermined shape and providing the surface zone with desired PDD, wherein the desired PDP is uniform or non-uniform.

17. The high-power laser system of claim 16, wherein the laser modules output respective source beams cumulative source beams having respective uniform or non-uniform powers PPDs and uniform or non-uniform output powers.
